(19) United States
(12) Patent Application Publication
(10) Pub. No.: US 2026/0249189 A1
(43) Pub. Date: Aug. 27, 2026

(54) INTERACTION CONTROL METHOD AND APPARATUS FOR GAME, AND ELECTRONIC DEVICE

(71) Applicant: NETEASE (HANGZHOU) NETWORK CO., LTD., Hangzhou (CN)

(72) Inventor: Zijian NI, Hangzhou (CN)

(21) Appl. No.: 18/874,663

(22) PCT Filed: Feb. 2, 2023
(86) PCT No.: PCT/CN2023/074310

§ 371 Date: Dec. 13, 2024

(30) Foreign Application Priority Data
Jun. 23, 2022 (CN) 202210720870.0

(51) Int. Cl. A63F 13/577; A63F 13/2145; A63F 13/837

(52) U.S. Cl. CPC A63F 13/577; A63F 13/2145; A63F 13/837; A63F 2300/308; A63F 2300/8076

(57) ABSTRACT

The present disclosure provides a method for controlling interactions in a game. The method includes: controlling a controlled virtual object to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation; in response to the controlled virtual object moving to an interactive area of a pickable auxiliary prop in the game scene, determining that the pickable auxiliary prop is a target auxiliary prop that matches a target configuration parameter; controlling the controlled virtual object to pick up the target auxiliary prop; and installing the target auxiliary prop on the target ballistic device prop to replace the first auxiliary prop.

### CROSS-REFERENCE TO RELATED APPLICATION

The present disclosure is a 371 national phase application of PCT Application No. PCT/CN 2023/074310 filed Feb. 2, 2023, which claims priority to Chinese patent application No. 202210720870.0, filed on Jun. 23, 2022 and entitled “INTERACTION CONTROL METHOD AND APPARATUS FOR GAME, AND ELECTRONIC DEVICE,” the entire contents of both of which applications are hereby incorporated by reference for all purposes.

### TECHNICAL FIELD

The present disclosure relates to the field of game technology, and in particular to an interaction control method and apparatus for a game, and an electronic device.

### BACKGROUND ART

In shooting games or other games that use ballistic device props, a player needs to select the ballistic devices to carry into the game play and set the pickup parameters of the ballistic devices, such as bullets, sighting devices, and various accessories, through the ballistic device configuration function, before participating in the game play. At the same time, the player can also set automatic pickup parameters through the automatic pickup function. The automatic pickup parameters are directed to the pickup parameters of all ballistic device props provided by the game. In the related art, the ballistic device configuration function and the automatic pickup function are two relatively independent functions, which may easily lead to the mismatch between the item automatically picked up during the game play and the current ballistic device configuration of the player, or even cause conflicts, thereby affecting the game achievement and game experience of the player.

It should be noted that the information disclosed in the background art section above is only provided to enhance the understanding of the background of the present disclosure, and therefore may include information that does not constitute the prior art known to those of ordinary skill in the art.

### SUMMARY

The present disclosure provides a method, apparatus, and electronic device for controlling interactions in a game, with which a picked-up auxiliary prop can better match a ballistic device prop that a player is currently configured with, thereby improving the game achievement and game experience of the player.

According to a first aspect, the present disclosure provides a method for controlling interactions in a game. The method includes: controlling a controlled virtual object to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation, where the first target parameter is a pickup parameter of a target auxiliary prop applicable to the target ballistic device prop provided by a game corresponding to a pickup function provided by the game, the first target parameter comprises a target auxiliary prop pickup parameter, the game scene is displayed in a graphical user interface of a terminal device, the controlled virtual object is located in the game scene and controlled by the terminal device, and a pickable auxiliary prop is placed at a preset position in the game scene; in response to the controlled virtual object moving to an interactive area of the pickable auxiliary prop in the game scene, determining that the pickable auxiliary prop is the target auxiliary prop that matches a target configuration parameter, where the target configuration parameter is determined in response to a setting operation, and the target configuration parameter comprise the first target parameter; controlling the controlled virtual object to pick up the target auxiliary prop; and installing the target auxiliary prop on the target ballistic device prop to replace the first auxiliary prop.

According a second aspect, the present disclosure provides a system, comprising one or more memories collectively containing one or more programs, and one or more processors, where the one or more processors are configured to, individually or collectively, perform the operations in the above method for controlling interactions in a game.

According a third aspect, the present disclosure provides one or more non-transitory computer-readable storage media containing, in any combination, computer program code that, when executed by a computer system, performs the operations in the above method for controlling interactions in a game.

It should be understood that the foregoing general description and the following detailed description are merely exemplary and explanatory and are not limitation of the present disclosure.

### BRIEF DESCRIPTION OF THE DRAWINGS

To describe the technical solutions of the specific embodiments of the present disclosure or the related art more clearly, the drawings to be used in the description of the specific embodiments or the related art are briefly introduced below. Apparently, the drawings described below represent merely some embodiments of the present disclosure. For those skilled in the art, other drawings may also be obtained based on these drawings without creative efforts.

FIG. 1 is a flow chart of an interaction control method for a game provided by an embodiment of the present disclosure;

FIG. 2 is a schematic diagram of a ballistic device configuration page provided by an embodiment of the present disclosure;

FIG. 3 is a schematic diagram of another ballistic device configuration page provided by an embodiment of the present disclosure;

FIG. 4 is a schematic structural diagram of an interaction control apparatus for a game provided by an embodiment of the present disclosure; and

FIG. 5 is a schematic diagram of an electronic device provided by an embodiment of the present disclosure.

### DETAILED DESCRIPTION

In order to make the purposes, technical solutions, and advantages of the embodiments of the present disclosure clearer, the technical solutions of the present disclosure will be clearly and completely described below in conjunction with the drawings. Apparently, the described embodiments are only some of the embodiments of the present disclosure, rather than all of the embodiments. All other embodiments obtained by those skilled in the art based on the embodiments in the present disclosure without any creative effort shall fall within the scope of protection of the present disclosure.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The disclosed method, apparatus, and electronic device for object selection operate as follows: control a controlled virtual object is controlled to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation, where the first target parameter is a pickup parameter of a target auxiliary prop applicable to the target ballistic device prop provided by a game corresponding to a pickup function provided by the game, the first target parameter comprises a target auxiliary prop pickup parameter, the game scene is displayed in a graphical user interface of a terminal device, the controlled virtual object is located in the game scene and controlled by the terminal device, and a pickable auxiliary prop is placed at a preset position in the game scene; in response to the controlled virtual object moving to an interactive area of the pickable auxiliary prop in the game scene, determining that the pickable auxiliary prop is the target auxiliary prop that matches a target configuration parameter, where the target configuration parameter is determined in response to a setting operation, and the target configuration parameter comprise the first target parameter; controlling the controlled virtual object to pick up the target auxiliary prop; and installing the target auxiliary prop on the target ballistic device prop to replace the first auxiliary prop.

In the disclosed embodiments, the first target parameter is an auxiliary prop pickup parameter for most ballistic device props, and the target configuration parameter is an auxiliary prop pickup parameter for the target ballistic device prop. Since the controlled virtual object carries the target ballistic device prop in the game play, by picking up an auxiliary prop through the target configuration parameter, the picked-up auxiliary prop can better match the target ballistic device prop and better conform to preferences and habits of the player, thereby improving the game achievement of the player. When the first target parameter conflicts with the target configuration parameter, by picking up the auxiliary prop through the target configuration parameter, confusion in the prop pickup logic can be avoided, thereby improving the game experience of the player.

To address the problem that items automatically picked up during a game play do not match or even conflict with the current ballistic device configuration of the player, the present embodiment provides a method, apparatus, and electronic device for controlling interactions in a game. This technology can be applied to shooting games or other games that use ballistic device props.

The interaction control method for a game in one of the embodiments of the present disclosure may be run on a local terminal device or a server. When the interaction control method for a game runs on a server, the method can be implemented and executed based on a cloud interaction system, where the cloud interaction system includes a server and a client device.

In some embodiments, various cloud applications, such as cloud gaming, can be run on the cloud interaction system. Take cloud gaming as an example. Cloud gaming refers to a gaming mode based on cloud computing. In the cloud gaming running mode, the game program running entity and the game screen presentation entity are separated. The storage and running of the interaction control method for a game are accomplished on the cloud gaming server. The client device serves to receive and send data and present the game screen. For example, the client device may be a display device with data transmission function close to the user side, such as a mobile terminal, TV, computer, PDA, and the like; but information processing is done by the cloud gaming server in the cloud. When playing the game, the player operates the client device to send operation instructions to the cloud gaming server. The cloud gaming server runs the game according to the operation instructions, encodes and compresses the game screen and other data, and returns them to the client device through the network. Finally, the client device decodes and outputs the game screen.

In some embodiments, taking a game as an example, the terminal device has a game program stored therein and is configured to present the game screen. The terminal device is configured to interact with the player through a graphical user interface, to download and install the game program and run it in a conventional manner through an electronic device. The terminal device may provide the graphical user interface to the player in a variety of ways. For example, the graphical user interface may be rendered and displayed on a display screen of the terminal, or provided to the player through holographic projection. For example, the terminal device may include the display screen and a processor. The display screen is configured to present a graphical user interface including a game screen, and the processor is configured to run the game, generate the graphical user interface, and control the display of the graphical user interface on the display screen.

An embodiment of the present disclosure provides an interaction control method for a game, in which a graphical user interface is provided by a terminal device, where the terminal device may be a local terminal device mentioned above, or may be a client device in the cloud interaction system mentioned above. A graphical user interface is provided by the terminal device, and the graphical user interface can display interface contents, such as a game scene screen, a communicative interaction window, and the like, according to the type of the application started.

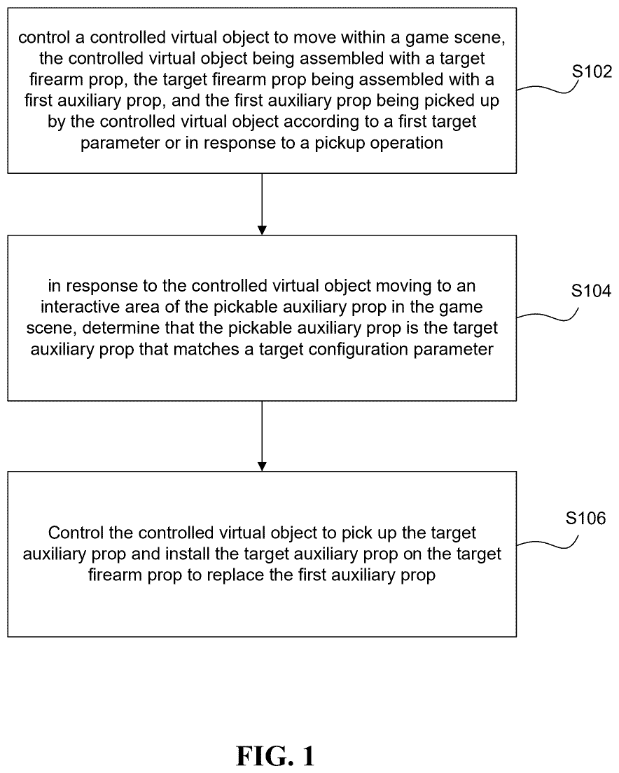

To facilitate understanding of the present embodiment, an interaction control method for a game disclosed in embodiments of the present is first introduced in detail. As shown in FIG. 1, the interaction control method for a game provides a graphical user interface by a terminal device, where the terminal device may be a local terminal device described above, or may be a client device described above.

A scene screen of a game scene is displayed in the graphical user interface; a controlled virtual object is located in the game scene, and the controlled virtual object is controlled by the terminal device; and a pickable auxiliary prop is placed at a preset position in the game scene. The controlled virtual object may be, for example, a virtual character, a virtual animal, or other avatars. The controlled virtual object is controlled by the terminal device. A player can issue various instructions through the terminal device to control the controlled virtual object to perform actions such as walking, running, jumping, shooting, and picking up items in the game scene. Typically, a virtual camera is provided in the game scene, and the virtual camera follows the controlled virtual object. When the controlled virtual object performs actions such as moving or turning, the position or orientation of the virtual camera changes, thereby changing the scene screen on the graphical user interface. In a third-person perspective, the scene screen includes the controlled virtual object, and in a first-person perspective, the scene screen does not include the controlled virtual object, or only includes part of the controlled virtual object, such as an arm.

Taking into account the needs of the game play, pickable auxiliary props are placed in advance in the game scene. The auxiliary props can be placed in the game scene randomly or according to a certain pattern. The auxiliary props may include ballistic devices, ballistic accessories, bullets, sighting devices, medicines, and various types of items that may be applied in the game play. The player can trigger a manual pickup instruction to control the controlled virtual object to pick up an auxiliary prop. The player can also preset an automatic pickup function to control the controlled virtual object to automatically pick up an auxiliary prop when a certain condition is met.

The interaction control method for a game includes the following steps.

In Step S102, the controlled virtual object is controlled to move within the game scene. The controlled virtual object is assembled with a target ballistic device prop, the target ballistic device prop is assembled with a first auxiliary prop, and the first auxiliary prop is picked up by the controlled virtual object according to a first target parameter or in response to a pickup operation. The first target parameter is the pickup parameter of a target auxiliary prop applicable to the ballistic device prop provided by the game corresponding to a pickup function provided by the game, and the first target parameter includes a target auxiliary prop pickup parameter.

Before participating in a game play, the player can set the first target parameter through the pickup function provided by the game. In some embodiments, the pickup function is also called the automatic pickup function. In the pickup function, the player can set a pickup parameter for the auxiliary prop of the ballistic device prop provided by the game. There are usually a variety of ballistic device props provided in the game, and different ballistic device props have different models, such as rifles, pistols, sniper rifles, submachine guns, or the like. The auxiliary props of the ballistic device props may include ballistic device accessories, bullets, sighting devices, and other props. The ballistic accessories may include muzzles, magazines, buttstocks, handgrips, or the like.

It should be noted that in the pickup function, the first target parameter prop that is set is applicable to all ballistic device props provided in the game, or most of the ballistic device props. Therefore the first target parameter is universal and is applicable to the target ballistic device props currently carried by the controlled virtual player, as well as other ballistic device props. The first target parameter mainly includes the pickup parameter of the auxiliary props of the ballistic device props, and the pickup parameter is set to control the pickup priority, pickup quantity, or the like, of the auxiliary props. For one type of auxiliary prop, the pickup quantity is set to control the total quantity of the auxiliary props that can be picked up. When the auxiliary prop has multiple models, the pickup order is controlled by the pickup priority. When the controlled virtual object does not currently have the auxiliary prop, a low-priority model can be picked up. When the controlled virtual object currently already has the auxiliary prop, only a model with a higher priority than the current auxiliary prop can be picked up, meanwhile the current auxiliary prop is replaced.

The auxiliary prop pickup parameter in the first target parameter is set as the pickup parameter of the auxiliary prop that controls the ballistic device prop. The auxiliary prop pickup parameter may include the pickup parameter corresponding to each type of auxiliary prop, for example, the pickup parameter of the muzzle auxiliary (or accessory), the pickup parameter of the magazine auxiliary (or accessory), the pickup parameter of the buttstock auxiliary (or accessory), the pickup parameter of the handgrip auxiliary (or accessory), and the like. Taking the pickup parameter of the handgrip auxiliary (or accessory) as an example, the pickup quantity of the handgrip accessories and the priority among various handgrip auxiliary models may be included.

Before participating in a game play, the player needs to select a target ballistic device prop to bring into the game play. For example, the target ballistic device prop is a rifle, and the target ballistic device prop has a specific model.

After the controlled virtual object participates in the game play, it moves within the game scene. The player controls the movement of the controlled virtual object within the game scene by controlling a moving control on the graphical user interface. At the beginning of the game play, the controlled virtual object is only assembled with the target ballistic device prop, and is not assembled with the first auxiliary prop. The controlled virtual object can pick up and assemble the first auxiliary prop while moving within the game scene.

In one embodiment, the player performs a pickup operation to control the controlled virtual object to pick up the first auxiliary prop and assemble it to the target ballistic device prop; and the pickup operation can be implemented through a pickup control on the graphical user interface. In another embodiment, an auxiliary prop pickup parameter is configured in the first target parameter. The auxiliary prop pickup parameter indicates that automatic pickup of the first auxiliary prop is allowed, and then the first auxiliary prop can be picked up by automatic pickup. When the first auxiliary prop has multiple models, the auxiliary prop pickup parameter may also include the priority among the models. In this embodiment, when the controlled virtual object automatically picks up the first auxiliary prop, it preferentially picks up the first auxiliary prop of a high-priority model.

In Step S104, in response to the controlled virtual object moving to an interactive area of the auxiliary prop in the game scene, it is determined that the pickable auxiliary prop is the target auxiliary prop that matches a target configuration parameter. The target configuration parameter is determined in response to a setting operation and the target configuration parameter includes the first target parameter.

Before participating in a game play, the player selects a target ballistic device prop to bring into the game and sets a target configuration parameter for the target ballistic device prop. In some embodiments, the process of setting the target configuration parameter for the target ballistic device prop is also called a ballistic device configuration function. After the player selects the target ballistic device prop, the target configuration parameter can be set for the target ballistic device prop. The target configuration parameter includes the pickup parameters of various auxiliary props of the target ballistic device prop. For example, the pickup parameter of the bullet prop applicable to the target ballistic device prop, the pickup parameter of the auxiliary prop applicable to the target ballistic device prop, and the pickup parameter of the sighting prop applicable to the target ballistic device prop.

Different ballistic device props match different auxiliary props. Therefore, the target configuration parameter is only applicable to the target ballistic device prop and may not be applicable to other ballistic device props. It should be noted that the pickup parameter of the auxiliary prop set in the target configuration parameter is set by the player for the target ballistic device prop, which is the auxiliary prop that the player prefers to use when using the target ballistic device prop.

Taking the target auxiliary prop pickup parameter in the target configuration parameter as an example, the player sets auxiliary (or accessory) A for the target ballistic device prop. In this embodiment, the auxiliary type and auxiliary model of auxiliary (or accessory) A will be recorded in the target auxiliary prop pickup parameter. The auxiliary (or accessory) recorded in the target auxiliary prop pickup parameter is set by the player for the target ballistic device prop. When the player uses the target ballistic device prop, he or she prefers to use the auxiliary recorded in the target auxiliary prop pickup parameter.

The target configuration parameter set for the target ballistic device prop may conflict with the aforementioned first target parameter. For example, for magazine accessories, there are three models of magazines, i.e., magazine 1, magazine 2, and magazine 3. In the first target parameter, the pickup priorities of magazine 1, magazine 2, and magazine 3 increase in sequence. In this embodiment, when the controlled virtual object picks up and installs magazine 2, and then picks up magazine 3, magazine 3 will be installed on the target ballistic device prop to replace magazine 2. However, magazine 2 is configured in the target configuration parameter. In this embodiment, after the controlled virtual object picks up and installs magazine 2, he/she finds magazine 3. Although magazine 3 has the highest priority in the first target parameter, magazine 3 does not match the target configuration parameter. In this embodiment, it is determined not to pick up magazine 3 based preferentially on the target configuration parameter.

In this embodiment, the target configuration parameter is a personalized pickup parameter set by the player based on the target ballistic device prop. Since the controlled virtual object carries the target ballistic device prop in the game play, picking up an auxiliary prop based on the target configuration parameter is beneficial for making full use of the target ballistic device prop. Meanwhile, since the target ballistic device prop is also applicable to the aforementioned first target parameter, which is a prop pickup parameter set for all or most of the ballistic device props in the game but may not sufficiently match the target ballistic device prop, when the first target parameter conflicts or contradicts with the target configuration parameter, an auxiliary prop of the target ballistic device prop is picked up based on the target configuration parameter, thereby improving the matching level between the picked-up prop and the ballistic device, and allowing more compliance with the preferences and habits of the player in using ballistic devices and props.

After the controlled virtual object enters the game play, in the game scene, when the controlled virtual object moves to the interactive area of the auxiliary prop, it is necessary to determine whether the auxiliary prop matches the target configuration parameter. The interactive area may be a scene area within a specified range of the auxiliary prop in the game scene, or in some embodiments, when an auxiliary prop appears in the scene screen, it can be understood that the controlled virtual object has entered the interactive area of the auxiliary prop.

From the above, it can be seen that the pickup parameter of the auxiliary prop for the target ballistic device prop is recorded in the target configuration parameter. If the auxiliary prop corresponding to the interactive area matches the target configuration parameter, the auxiliary prop can be determined as the target auxiliary prop, which is the prop to be picked up. In this step, if the auxiliary prop matches the target configuration parameter but does not match the aforementioned first target parameters, in this embodiment, the first target parameter is no longer taken into account, and it is determined whether the auxiliary prop is the target auxiliary prop based only on the target configuration parameter. In addition, if the auxiliary prop does not match the target configuration parameter, but matches the aforementioned first target parameter, in this embodiment, the auxiliary prop cannot be used as the target auxiliary prop either.

In one embodiment, a specific prop model of a certain prop type may be saved in the target configuration parameter. If the auxiliary prop is of the same prop type and the same prop model as in the target configuration parameter, the auxiliary prop may be considered as the target auxiliary prop. In another embodiment, the priorities of multiple prop models of a certain prop type may be saved in the target configuration parameter. Then the props are picked up according to the priorities of the multiple prop models in the target configuration parameter until the prop model with the highest priority in the target configuration parameter is picked up.

In Step S106, the controlled virtual object is controlled to pick up the target auxiliary prop and install the target auxiliary prop on the target ballistic device prop to replace the first auxiliary prop.

From the above, it can be seen the first auxiliary prop is a prop that is picked up by the controlled virtual object in response to the pickup operation or based on the first target parameter. If the prop was picked up based on the first target parameter, it means that the priority of the first auxiliary prop is lower than the priority of the prop configured in the target configuration parameter, or the priority of the first auxiliary prop in the target configuration parameter is also low. Since the controlled virtual object has not encountered a higher-level auxiliary prop at this time, an automatic pickup operation is performed on the first auxiliary prop.

However, as the game play progresses, the controlled virtual object finds a target auxiliary prop that matches the target configuration parameter, or in other words, the controlled virtual object finds a target auxiliary prop that has a higher priority than the first auxiliary prop in the target configuration parameter. In this embodiment, the target auxiliary prop is installed on the target ballistic device prop to replace the first auxiliary prop.

In the interaction control method for a game, a controlled virtual object is controlled to move within a game scene, the controlled virtual object being assembled with a target ballistic device prop, the target ballistic device prop being assembled with a first auxiliary prop, and the first auxiliary prop being a prop that is picked up by the controlled virtual object according to a first target parameter or a prop that is picked up by the controlled virtual object in response to a pickup operation, where the first target parameter is the pickup parameter of the auxiliary prop suitable for the ballistic device prop provided by the game corresponding to a pickup function provided by the game, and the first target parameter includes an auxiliary prop pickup parameter; in response to the controlled virtual object moving to an interactive area of the auxiliary prop in the game scene, it is determined that the auxiliary prop is a target auxiliary prop that matches a target configuration parameter, where the target configuration parameter is a target configuration parameter of the target ballistic device prop that is determined in response to a setting operation and according to the setting operation, the target configuration parameter is the pickup parameter of the auxiliary prop suitable for the target ballistic device prop, and the target configuration parameter includes a target auxiliary prop pickup parameter; and the controlled virtual object is controlled to pick up the target auxiliary prop and install the same on the target ballistic device prop, so as to replace a first auxiliary prop. In this method, the first target parameter is an auxiliary prop pickup parameter for most ballistic device props, and the target configuration parameter is an auxiliary prop pickup parameter for the target ballistic device prop. Since the controlled virtual object carries the target ballistic device prop in the game play, by picking up an auxiliary prop through the target configuration parameter, the picked-up auxiliary prop can better match the target ballistic device prop and better conform with preferences and habits of the player, thereby improving the game achievement of the player. When the first target parameter conflicts with the target configuration parameter, by picking up the auxiliary prop through the target configuration parameter, confusion in the prop pickup logic can be avoided, thereby improving the game experience of the player.

The first target parameter is the pickup parameter of the auxiliary prop applicable to the ballistic device prop provided by the game, and are set for all or most of the ballistic device props. The first target parameter includes an auxiliary prop pickup parameter, a bullet prop pickup parameter, and a sighting prop pickup parameter, which are described respectively below.

The auxiliary prop pickup parameter may include at least one of a muzzle prop pickup parameter, a magazine prop pickup parameter, a handgrip prop pickup parameter, and a buttstock prop pickup parameter; the auxiliary prop corresponding to each auxiliary prop pickup parameter is preset with at least one auxiliary model, and each auxiliary model is configured with a pickup priority; and the auxiliary prop pickup parameter is configured to: if the auxiliary model of the first auxiliary prop assembled on the target ballistic device prop is configured with a first priority, control to pick up the auxiliary model of the first auxiliary prop with a priority higher than the first priority in the game scene.

When the target ballistic device prop is assembled with the first auxiliary prop, and the priority of the first auxiliary prop is not the highest, in this embodiment, when the controlled virtual object encounters an auxiliary prop with a higher priority than the first auxiliary prop, it is controlled to pick up the auxiliary prop; and when the controlled virtual object encounters an auxiliary prop with a lower priority than the first auxiliary prop, it is controlled not to pick up the auxiliary prop. If the first auxiliary prop has the highest priority, no more accessories of the same type as the first auxiliary prop will be picked up later.

Taking the pickup parameter of magazine props as an example, there are three models of magazine props, namely magazine 1, magazine 2, and magazine 3 with priorities increasing in sequence. The process of picking up a magazine based on the magazine prop pickup parameter is as follows: in the initial state, the target ballistic device prop is not assembled with a magazine. In this embodiment, the controlled virtual object first picks up magazine 1 and assembles it on the target ballistic device prop, and then picks up magazine 2. Since magazine 2 has a higher priority than magazine 1, the controlled virtual object assembles magazine 2 to the target ballistic device prop to replace magazine 1. Then, the controlled virtual object picks up magazine 3. Since magazine 3 has a higher priority than magazine 2, the controlled virtual object assembles magazine 3 to the target ballistic device prop to replace magazine 2. Since magazine 3 is the magazine with the highest priority, if the controlled virtual object encounters a magazine later, it will not pick up the magazine.

In another example, the controlled virtual object first picks up magazine 1 and assembles it to the target ballistic device prop, and then picks up magazine 3. Since magazine 3 has a higher priority than magazine 1, the controlled virtual object assembles magazine 3 to the target ballistic device prop to replace magazine 1. Then, the controlled virtual object picks up magazine 2. Since magazine 2 has a lower priority than magazine 3, the controlled virtual object does not pick up magazine 2 in this embodiment, and will not pick up any more magazine even if it encounters any magazine later.

The first target parameter further includes a bullet prop pickup parameter, and the bullet prop pickup parameter is configured to: control to pick up a first bullet pickup quantity of bullets of a specified bullet type; and if the number of bullets of the specified bullet type that have been picked up reaches the first bullet pickup quantity, no more bullet of the specified bullet type is to be picked up.

Here, one specified bullet type may be provided, or multiple specified bullet types may be provided. For each specified bullet type, a first bullet pickup quantity of the specified bullet type may be set in the bullet prop pickup parameter. The first bullet pickup quantity may be understood as the maximum pickup quantity of the specified bullet type that can be picked up by the controlled virtual object in the game scene. When the controlled virtual object moves within the game scene, it can continuously pick up bullets of the specified bullet type until the number of picked-up bullets meets the first bullet pickup quantity, then no more bullet will be picked up later.

The first target parameter further includes a sighting prop pickup parameter, and the sighting prop pickup parameter is configured to: control to pick up a first sighting-device pickup quantity of sighting devices of a specified sighting-device type; and if the number of sighting devices of the specified sighting-device type that have been picked up reaches the first sighting-device pickup quantity, then no more sighting device of the specified sighting-device type will be picked up.

Here, one specified sighting-device type may be provided, or multiple specified sighting-device types may be provided. For each specified sighting-device type, a first sighting-device pickup quantity of the specified sighting-device type may be set in the sighting prop pickup parameter. The first sighting-device pickup quantity may be understood as the maximum pickup quantity of the specified sighting-device type that can be picked up by the controlled virtual object in the game scene. When the controlled virtual object moves within the game scene, it can continuously pick up bullets of the specified sighting-device type until the number of picked-up bullets meets the first sighting-device pickup quantity, then no more bullet will be picked up later.

The target configuration parameter is the pickup parameter of the auxiliary prop set for the target ballistic device prop; and the target configuration parameter may include a target auxiliary prop pickup parameter, a target bullet prop pickup parameter, and a target sighting prop pickup parameter, which are described respectively below.

The target auxiliary prop pickup parameter includes a first auxiliary model of the target auxiliary set for the target ballistic device prop, and the target auxiliary prop pickup parameter is configured to: if the auxiliary type of the target auxiliary prop is preset with at least one auxiliary model, configure the first auxiliary model to have the highest pickup priority.

The target auxiliary prop pickup parameter may also be understood as, when the target ballistic device prop is assembled with an auxiliary of the first auxiliary model, no more auxiliary of the same type as the target auxiliary will be picked up later. For auxiliary models that are not set in the target auxiliary prop pickup parameter, the priority sequence among them can follow the first target parameter.

Taking magazine accessories as an example, there are three models of magazine props, namely magazine 1, magazine 2, and magazine 3; and in the first target parameter, the priorities of magazine 1, magazine 2, and magazine 3 increase in sequence. In the target auxiliary prop pickup parameter, the auxiliary model of the magazine auxiliary (or accessory) is set to magazine 2. In this embodiment, the priorities of magazine 1, magazine 3, and magazine 2 increase in sequence, and magazine 2 has the highest pickup priority. Meanwhile, magazine 1 and magazine 3 are not set in the target auxiliary prop pickup parameter. Therefore, the priority sequence between magazine 1 and magazine 3 follows the first target parameter.

On this basis, in response to the controlled virtual object moving to the interactive area of the auxiliary prop in the game scene, if the auxiliary type of the auxiliary prop is the same as the auxiliary type of the target auxiliary prop, and the auxiliary model of the auxiliary prop is the first auxiliary model, the auxiliary prop is determined as the target auxiliary prop that matches the target configuration parameter.

Then the controlled virtual object can be controlled to pick up the target auxiliary prop and install the target auxiliary prop on the target ballistic device prop to replace the first auxiliary prop. For example, the magazine recorded in the target auxiliary prop pickup parameter is magazine 2, and the first auxiliary prop is magazine 3. Since magazine 2 has the highest priority, magazine 2 is installed on the target ballistic device prop to replace magazine 3.

Further, after the target auxiliary of the first auxiliary model is assembled to the target ballistic device prop, in response to the controlled virtual object moving to the interactive area of the auxiliary prop in the game scene, it is determined that the auxiliary prop is an assemblable auxiliary prop that matches the type of the target ballistic device prop, and that the auxiliary model of the assemblable auxiliary prop is a second auxiliary model, where in the auxiliary prop pickup parameter of the first target parameter, the second auxiliary model has the highest pickup priority, and the second auxiliary model is different from the first auxiliary model; and it is determined that the auxiliary prop is not a target auxiliary prop that matches the target configuration parameter.

The assemblable auxiliary prop that matches the type of the target ballistic device prop can be understood as an auxiliary prop that can be installed on the target ballistic device prop, or an auxiliary prop that can be used by the target ballistic device prop. For example, the target ballistic device prop is a rifle, and the assemblable auxiliary props may be, for example, muzzle accessories, handgrip accessories, magazine accessories, and the like, that match the rifle; since rifles and submachine guns are different types of ballistic devices, the auxiliary props used by them are also different, and muzzle accessories that are only applicable to submachine guns cannot be used as assemblable auxiliary props for rifles.

Furthermore, the auxiliary model of the auxiliary prop is a second auxiliary model. In the first target parameter, the second auxiliary model has the highest pickup priority; but in the target configuration parameter, the first auxiliary model is configured. According to the target configuration parameter, the first auxiliary model has the highest pickup priority, and the pickup priority of the second auxiliary model is lower than that of the first auxiliary model. In this embodiment, the auxiliary prop of the second auxiliary model is not used as the target auxiliary prop. Since the target ballistic device prop has already been installed with the target auxiliary of the first auxiliary model with the highest priority, no more auxiliary prop of the second auxiliary model will be picked up in this embodiment.

In addition, before picking up the target auxiliary corresponding to the target configuration parameter, the controlled virtual object may first pick up an auxiliary prop that is of the same auxiliary type as the target auxiliary but of a different model. In this embodiment, the auxiliary prop is picked up based on the priorities of models of this auxiliary type in the first target parameter. Therefore, after the target auxiliary is set in the first target parameter, the model of the target auxiliary has the highest priority, and again, the priority sequence of other models of the same auxiliary type as the target auxiliary can be acquired by referring to the first target parameter. For example, four auxiliary models of muzzle accessories are provided, namely muzzle 1, muzzle 2, muzzle 3, and muzzle 4. In the first target parameter, the pickup priorities of muzzle 1, muzzle 2, muzzle 3, and muzzle 4 are in an ascending order. Meanwhile, muzzle 3 is configured in the target configuration parameter. In this embodiment, the pickup priorities of the four auxiliary models, muzzle 1, muzzle 2, muzzle 3, and muzzle 4 are in an ascending order. Among them, muzzle 3 has the highest pickup priority, while the pickup priority sequence of muzzle 1, muzzle 2, and muzzle 4 remains unchanged.

On this basis, in response to the controlled virtual object moving to the interactive area of the auxiliary prop in the game scene, it is determined that the auxiliary type of the auxiliary prop is the same as the auxiliary type of the target auxiliary prop, and that the auxiliary model of the auxiliary prop is a third auxiliary model, where the third auxiliary model is different from the first auxiliary model; it is determined that the auxiliary type of the first auxiliary prop currently assembled on the target ballistic device prop is the same as the auxiliary type of the target auxiliary prop, and that the auxiliary model of the first auxiliary prop is a fourth auxiliary model, where the fourth auxiliary model is different from the first auxiliary model; the pickup priority for the third auxiliary model and the pickup priority for the fourth auxiliary model are acquired from the first target parameter; if the pickup priority of the third auxiliary model is lower than the pickup priority of the fourth auxiliary model, it is controlled not to automatically pick up the auxiliary prop; and if the pickup priority of the third auxiliary model is higher than the pickup priority of the fourth auxiliary model, it is controlled to pick up the auxiliary prop.

In the above embodiment, since the model of the first auxiliary prop currently assembled on the target ballistic device prop is the fourth auxiliary model, the auxiliary model of the auxiliary prop encountered by the controlled virtual object is the third auxiliary model, and neither of the third auxiliary model and the fourth auxiliary model is the auxiliary model in the target configuration parameter, in this embodiment, it is controlled whether to pick up the auxiliary prop according to the pickup priorities of the auxiliary models in the first target parameter.

In the above method, the pickup of the auxiliary prop of the target ballistic device prop is controlled preferentially based on the target configuration parameter. If the auxiliary set by the target configuration parameter has not been picked up, the pickup of the auxiliary prop of the target ballistic device prop is controlled based on the first target parameter, so that the target configuration parameter and the first target parameter do not conflict with each other and can be used in coordination, thereby providing a method of auxiliary prop pickup control that is more diversified and in more compliance with the use preferences of the player.

Further, if the pickup function corresponding to the first target parameter is turned off, it is determined that the first target parameter is invalid, and it is controlled not to automatically pick up an auxiliary of a different auxiliary model from the target auxiliary. In this embodiment, the pickup priority sequence among the auxiliary models in the first target parameter is no longer applicable. Meanwhile, only the auxiliary model of the target auxiliary is set in the target auxiliary parameter. The auxiliary model of the target auxiliary has the highest pickup priority, and the pickup priorities of other auxiliary models are not set. In this embodiment, only the target auxiliary is picked up, and no more auxiliary of a different auxiliary model from the target auxiliary is picked up.

The target configuration parameter further includes a target bullet prop pickup parameter, and the target bullet prop pickup parameter is configured to: control to pick up a second bullet pickup quantity of bullets of the specified bullet type, where the specified bullet type matches the target ballistic device prop; and if the second bullet pickup quantity is different from the first bullet pickup quantity of bullets of the specified bullet type in the first target parameter, the greater value of the first bullet pickup quantity and the second bullet pickup quantity is determined as the pickup quantity of bullets of the specified bullet type.

For a target ballistic device prop, usually only one or a small number of types of bullets can be used. The first bullet pickup quantity of various specified bullet types may be set in the first target parameter; meanwhile, the second bullet pickup quantity of the bullet type matching the target ballistic device prop is further set in the target configuration parameter. Usually, the player sets the first target parameter and the target auxiliary parameter in different windows or pages. Therefore, the first bullet pickup quantity and the second bullet pickup quantity for the same bullet type may be different. In this embodiment, the greater value of the first bullet pickup quantity and the second bullet pickup quantity is determined as the pickup quantity of bullets of the specified bullet type. Specifically, if the first bullet pickup quantity is greater than the second bullet pickup quantity, the first bullet pickup quantity is determined as the pickup quantity of bullets of the specified bullet type; and if the first bullet pickup quantity is less than the second bullet pickup quantity, the second bullet pickup quantity is determined as the pickup quantity of bullets of the specified bullet type.

There is another situation where multiple target ballistic device props are provided and all match bullets of the specified bullet type, and multiple second bullet pickup quantities are provided. Put another way, the controlled virtual object is assembled with multiple target ballistic device props which may be of the same type or different types but match the same bullet type. In this embodiment, when the player sets the bullet pickup quantity for each target ballistic device prop separately, the setting may be done in different pages. In this embodiment, each target ballistic device prop corresponds to a different second bullet pickup quantity. Considering that multiple target ballistic device props match the same bullet type, in this embodiment, if the multiple second bullet pickup quantities are different, the second bullet pickup quantity with the greatest value is used as the final second bullet pickup quantity.

As an example, the target ballistic device props assembled on the controlled virtual object include ballistic device A and ballistic device B, both of which use bullet type K. In the configuration page of ballistic device A, the configured second bullet pickup quantity of bullet type K is 500, and on the configuration page of ballistic device B, the configured second bullet pickup quantity of bullet type K is 700. In this embodiment, the second bullet pickup quantity of bullet type K is determined to be 700.

In some embodiments, if the second bullet pickup quantity is different from the first bullet pickup quantity of bullets of the specified bullet type in the first target parameter, the second bullet pickup quantity is determined as the pickup quantity of bullets of the specified bullet type.

In some embodiments, the second bullet pickup quantity set in the target auxiliary parameter is used as a reference, and regardless of the size of the first bullet pickup quantity in the first target parameter, only the second bullet pickup quantity is used as the pickup quantity of bullets of the specified bullet type. Therefore, for the same type of bullets, the bullet pickup quantity set in the target configuration parameter takes precedence. When no bullet pickup quantity is set for this type in the target configuration parameter, the pickup quantity of this type of bullets set in the first target parameter can be used as the final pickup quantity.

The target configuration parameter further includes a target sighting prop pickup parameter; the target sighting prop pickup parameter is configured to: control to pick up the first sighting-device type set for the target ballistic device prop; the sighting-device type may include a red dot sighting telescope device, a four-times sighting telescope device, an eight-times sighting telescope device, and the like; and the first sighting-device type may be one of them.

In response to the controlled virtual object moving to an interactive area of a pickable sighting device in the game scene, it is determined that the sighting-device type of the pickable sighting device is a first sighting-device type; and the controlled virtual object is controlled to pick up the pickable sighting device and install the pickable sighting device on the target ballistic device prop. In response to the controlled virtual object moving to the interactive area of the pickable sighting device in the game scene, it is determined that the sighting-device type of the pickable sighting device is a second sighting-device type, where the second sighting-device type is different from the first sighting-device type; and the controlled virtual object is controlled not to pick up the pickable sighting device.

In the above embodiment, only the sighting devices of the first sighting-device type configured in the target configuration parameter are picked up, and no more other types of sighting devices are picked up.

It is to be noted that the first sighting-device type is a sighting-device type determined in response to a setting operation for a target sighting prop pickup parameter. In one embodiment, the setting operation can be performed in the ballistic device configuration page for the target ballistic device prop.

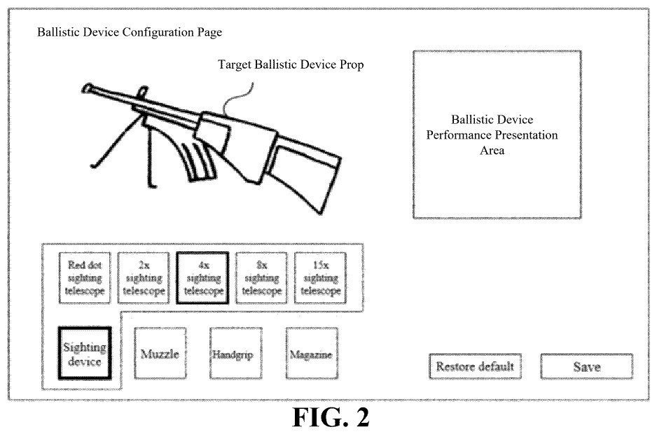

As shown in FIG. 2, the target ballistic device prop is presented in the ballistic device configuration page, and the ballistic device performance, for example, performance parameters such as damage, range, rate of fire, recoil, and magazine capacity, of the target ballistic device prop can be displayed in the ballistic device performance presentation area. At the bottom of the page are displayed selection controls for various props related to the target ballistic device prop, such as sighting devices, muzzles, handgrips, magazines, and the like. Once the sighting-device control is selected by the player, various sighting-device types matching the target ballistic device prop are displayed on the upper part of the sighting-device control, such as a red dot sighting telescope, a 2× sighting telescope, a 4× sighting telescope, an 8× sighting telescope, a 15× sighting telescope, and the like. The player can select the desired sighting-device type through clicking. The selected sighting-device type is the first sighting-device type mentioned above.

If the setting function for the target ballistic device prop is turned on and a setting operation of the target sighting prop pickup parameter for the target ballistic device prop is not received, a default sighting-device type of the target ballistic device prop is acquired and the default sighting-device type is determined as the first sighting-device type. In some embodiments, a default sighting-device type can be preset for each type of ballistic device prop. For example, the default sighting-device type for a sniper rifle is an 8× sighting telescope, and the default sighting-device type for ballistic devices other than a sniper rifle is a red dot sighting telescope. If the player does not perform the setting operation of the target sighting prop pickup parameter for the target ballistic device prop, which refers that the player does not select the sighting-device type in the ballistic device configuration page, in this embodiment, in order to avoid the target sighting prop pickup parameter of the target ballistic device prop being null, the preset default sighting-device type can be used as the first sighting-device type.

Furthermore, multiple of the target ballistic device props are provided; the controlled virtual object is controlled to pick up the pickable sighting device; and the position sequence numbers of the multiple target ballistic device props are acquired, and the pickable sighting device is installed on the target ballistic device prop with a position sequence number that meets a preset condition. In this embodiment, the controlled virtual object is configured with multiple target ballistic device props. When a pickable sighting device is picked up, and the pickable sighting device matches multiple controlled virtual objects, in this embodiment, the pickable sighting device is installed on one of the target ballistic device props according to the position sequence numbers of the multiple target ballistic device props. When the controlled virtual object is configured with multiple target ballistic device props, the multiple target ballistic device props can be placed in different positions based on the importance, frequency of use, and the like, of the multiple target ballistic device props. Typically, the target ballistic device prop in the first position is a ballistic device that is used frequently by the player. In this embodiment, the pickable sighting device can be installed on the target ballistic device prop in the first position.

If the setting function for the target ballistic device prop is turned off, it is determined that the target configuration parameter is invalid; and the controlled virtual object is controlled to pick up a sighting device in the game scene according to the sighting prop pickup parameter in the first target parameter. When the setting function is turned off, the first sighting-device type set in the target configuration parameter becomes invalid. In this embodiment, it is no longer only the sighting device corresponding to the first sighting-device type that is picked up. In the first target parameter, the pickup quantity of each type of sighting device can be set. In this embodiment, the sighting device is picked up in the game scene according to the first target parameter. For a certain sighting-device type, if the picked-up quantity reaches the set pickup quantity, no more sighting device of this type will be picked up later.

Furthermore, due to the invalidation of the target configuration parameter, in this embodiment, after the controlled virtual object picks up the sighting device, the sighting device is no longer automatically assembled to the target ballistic device prop. In this embodiment, the sighting device needs to be assembled manually. Specifically, it is controlled to place the picked-up sighting device in a virtual container carried by the controlled virtual object; and it is controlled to assemble the sighting device to the target ballistic device prop in response to an assembly operation for the sighting device in the virtual container. After the time limitation of the target configuration parameter, the prop picked up by the controlled virtual object will be placed in the virtual container, such as a backpack container. When the player performs the assembly operation for a sighting device in the virtual container, the sighting device will be assembled to the target ballistic device prop.

In another mode, in response to the controlled virtual object picking up the first ballistic device prop and the first ballistic device prop matching the picked-up sighting device in the virtual container carried by the controlled virtual object, the picked-up sighting device is installed on the first ballistic device prop. In the game scene, the controlled virtual object will not only pick up auxiliary props, but may also pick up ballistic device props. When the controlled virtual object picks up a first ballistic device prop, if there is a sighting device matching the first ballistic device prop in the virtual container, the sighting device can be automatically installed on the first ballistic device prop, thereby realizing automatic installation of the sighting device.

In addition, if the setting function for the target ballistic device prop is turned on, a setting interface of the first target parameter is displayed in response to a triggering operation for the pickup function. In the setting interface of the first target parameter, a setting control for the sighting prop pickup parameter is not displayed, or the setting control for the sighting prop pickup parameter is in an untriggerable state.

In this embodiment, the target sighting prop pickup parameter of the target ballistic device prop, including the first sighting-device type included in the target configuration parameter, is to be set only in the setting page for the target ballistic device prop. In order to avoid conflicts in setting, the sighting prop pickup parameter is no longer allowed to be set in the setting page of the first target parameter. For example, the setting control for the sighting prop pickup parameter is not displayed, or the setting control for the sighting prop pickup parameter is grayed out. In the grayed-out display state, the setting control cannot be triggered.

The following embodiments describe the configuration method of the target configuration parameter of the target ballistic device prop.

In response to a triggering operation for the target ballistic device prop, a parameter setting window for the target ballistic device prop is displayed. The parameter setting window includes a first setting control for the target auxiliary prop pickup parameter, a second setting control for the target bullet prop pickup parameter, and a third setting control for the target sighting prop pickup parameter of the target ballistic device prop.

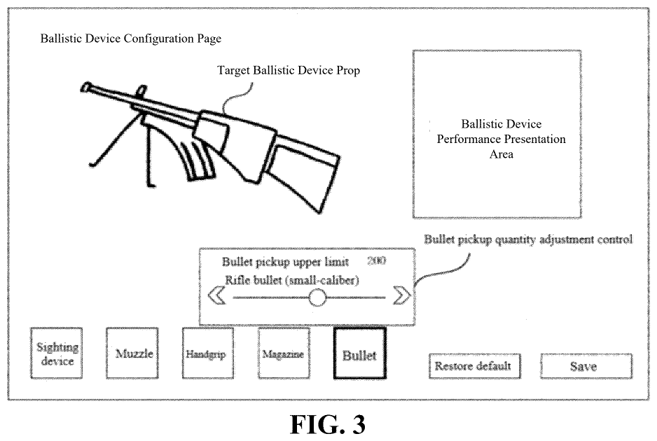

FIG. 3 is used as an example. The ballistic device configuration page in FIG. 3 is an example of a parameter setting window, in which the first setting control for the target auxiliary prop pickup parameter includes a muzzle control, a handgrip control, and a magazine control. When the ballistic device props are different, the types of the first setting controls are usually different. The second setting control for the target bullet prop pickup parameter is the bullet control, and the third setting control for the target sighting prop pickup parameter is the sighting-device control. The player can configure the corresponding parameters by clicking on different controls. For example, click on the sighting-device parameter, and a variety of sighting devices that can be configured for the target ballistic device prop will be displayed in the page, and the player can select a sighting device from the variety of sighting devices.

The target bullet prop pickup parameter is configured to: control to pick up the second bullet pickup quantity of bullets of the specified bullet type, where the specified bullet type matches the target ballistic device prop. In response to the triggering operation for the second setting control for the target bullet prop pickup parameter, the bullet pickup quantity adjustment control is displayed; and in response to the triggering operation for the bullet pickup quantity adjustment control, the second bullet pickup quantity in the target bullet prop pickup parameter is adjusted.

Continuing to refer to FIG. 3, the bullet control is the second setting control. After the bullet control is triggered, the bullet pickup quantity adjustment control is displayed. In the control, a sliding bar is displayed. By adjusting the position of the sliding control on the sliding bar, the second bullet pickup quantity can be adjusted. There are also controls for reducing and increasing the pickup quantity provided on the left and right sides of the sliding bar. The second bullet pickup quantity can also be adjusted through adjustment to these two controls.

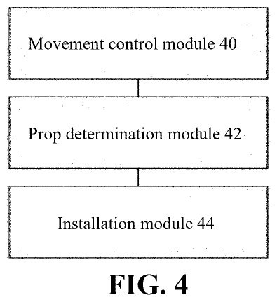

Corresponding to the method embodiment described above, and referring to the structural schematic diagram of an interaction control apparatus for a game shown in FIG. 4, a graphical user interface is provided by a terminal device; a scene screen of a game scene is displayed in the graphical user interface; a controlled virtual object is located in the game scene, and the controlled virtual object is controlled by the terminal device; and a pickable auxiliary prop is placed at a preset position in the game scene. This apparatus includes:
a movement control module 40 configured to control a controlled virtual object to move within a game scene. The controlled virtual object is assembled with a target ballistic device prop, the target ballistic device prop is assembled with a first auxiliary prop, and the first auxiliary prop is a prop that is picked up by the controlled virtual object according to a first target parameter or a prop that is picked up by the controlled virtual object in response to a pickup operation. The first target parameter is the pickup parameter of the auxiliary prop suitable for the ballistic device prop provided by the game corresponding to a pickup function provided by the game, and the first target parameter includes an auxiliary prop pickup parameter.

The apparatus also includes a prop determination module 42 configured to, in response to the controlled virtual object moving to an interactive area of the auxiliary prop in the game scene, determine that the auxiliary prop is a target auxiliary prop that matches a target configuration parameter. The target configuration parameter is a target configuration parameter of the target ballistic device prop that is determined in response to a setting operation and according to the setting operation, the target configuration parameter is the pickup parameter of the auxiliary prop suitable for the target ballistic device prop, and the target configuration parameter includes a target auxiliary prop pickup parameter.

The apparatus also includes an installation module 44 configured to control the controlled virtual object to pick up the target auxiliary prop and install the target auxiliary prop on the target ballistic device prop to replace the first auxiliary prop.

In the interaction control apparatus for a game, a controlled virtual object is controlled to move within a game scene, the controlled virtual object being assembled with a target ballistic device prop, the target ballistic device prop being assembled with a first auxiliary prop, and the first auxiliary prop being a prop that is picked up by the controlled virtual object according to a first target parameter or a prop that is picked up by the controlled virtual object in response to a pickup operation. The first target parameter is the pickup parameter of the auxiliary prop suitable for the ballistic device prop provided by the game corresponding to the pickup function provided by the game, and the first target parameter includes an auxiliary prop pickup parameter. In response to the controlled virtual object moving to an interactive area of the auxiliary prop in the game scene, it is determined that the auxiliary prop is a target auxiliary prop that matches a target configuration parameter. The target configuration parameter is a target configuration parameter of the target ballistic device prop that is determined in response to a setting operation and according to the setting operation. The target configuration parameter is the pickup parameter of the auxiliary prop suitable for the target ballistic device prop, and the target configuration parameter includes a target auxiliary prop pickup parameter. The controlled virtual object is controlled to pick up the target auxiliary prop and install the same to the target ballistic device prop, so as to replace a first auxiliary prop. In this method, the first target parameter is an auxiliary prop pickup parameter for most ballistic device props, and the target configuration parameter is an auxiliary prop pickup parameter for the target ballistic device prop. Since the controlled virtual object carries the target ballistic device prop in the game play, by picking up an auxiliary prop through the target configuration parameter, the picked-up auxiliary prop can better match the target ballistic device prop and better conform with preferences and habits of the player, thereby improving the game achievement of the player. When the first target parameter conflicts with the target configuration parameter, by picking up the auxiliary prop through the target configuration parameter, confusion in the prop pickup logic can be avoided, thereby improving the game experience of the player.

The auxiliary prop pickup parameter includes at least one of a muzzle prop pickup parameter, a magazine prop pickup parameter, a handgrip prop pickup parameter, and a buttstock prop pickup parameter; the auxiliary prop corresponding to each auxiliary prop pickup parameter is preset with at least one auxiliary model, and each auxiliary model is configured with a pickup priority; and the auxiliary prop pickup parameter is configured to: if the auxiliary model of the first auxiliary prop assembled on the target ballistic device prop is configured with a first priority, control to pick up the auxiliary model of the first auxiliary prop with a priority higher than the first priority in the game scene.

The first target parameter further includes a bullet prop pickup parameter, and the bullet prop pickup parameter is configured to: control to pick up a first bullet pickup quantity of bullets of a specified bullet type; and if the number of bullets of the specified bullet type that have been picked up reaches the first bullet pickup quantity, pick up no more bullets of the specified bullet type.

The first target parameter further includes a sighting prop pickup parameter, and the sighting prop pickup parameter is configured to: control to pick up a first sighting-device pickup quantity of sighting devices of a specified sighting-device type; and if the number of sighting devices of the specified sighting-device type that have been picked up reaches the first sighting-device pickup quantity, pick up no more sighting devices of the specified sighting-device type.

The target auxiliary prop pickup parameter includes a first auxiliary model of the target auxiliary set for the target ballistic device prop, and the target auxiliary prop pickup parameter is configured to: if the auxiliary type of the target auxiliary is preset with at least one auxiliary model, configure the first auxiliary model to have the highest pickup priority.

The prop determination module is further configured to: in response to the controlled virtual object moving to the interactive area of the auxiliary prop in the game scene, if the auxiliary type of the auxiliary prop is the same as the auxiliary type of the target auxiliary prop, and the auxiliary model of the auxiliary prop is the first auxiliary model, determine the auxiliary prop to be a target auxiliary prop that matches the target configuration parameter.

The apparatus further includes a second determination module configured to: in response to the controlled virtual object moving to the interactive area of the auxiliary prop in the game scene, determine that the auxiliary prop is an assemblable auxiliary prop that matches the type of the target ballistic device prop, and that the auxiliary model of the assemblable auxiliary prop is a second auxiliary model, where in the auxiliary prop pickup parameter of the first target parameter, the second auxiliary model has the highest pickup priority, and the second auxiliary model is different from the first auxiliary model; and determine that the auxiliary prop is not a target auxiliary prop that matches the target configuration parameter.

The apparatus further includes a prop pickup module configured to: in response to the controlled virtual object moving to the interactive area of the auxiliary prop in the game scene, determine that the auxiliary type of the auxiliary prop is the same as the auxiliary type of the target auxiliary prop, and that the auxiliary model of the auxiliary prop is a third auxiliary model, where the third auxiliary model is different from the first auxiliary model; determine that the auxiliary type of the first auxiliary prop currently assembled on the target ballistic device prop is the same as the auxiliary type of the target auxiliary prop, and that the auxiliary model of the first auxiliary prop is a fourth auxiliary model, where the fourth auxiliary model is different from the first auxiliary model; the pickup priority for the third auxiliary model and the pickup priority for the fourth auxiliary model are acquired from the first target parameter; if the pickup priority of the third auxiliary model is lower than the pickup priority of the fourth auxiliary model, control not to automatically pick up the auxiliary prop; and if the pickup priority of the third auxiliary model is higher than the pickup priority of the fourth auxiliary model, control to pick up the auxiliary prop.

The apparatus further includes a pickup control module configured to: if a pickup function corresponding to the first target parameter is turned off, determine that the first target parameter is invalid, and control not to automatically pick up an auxiliary of a different auxiliary model from the target auxiliary.

The target configuration parameter further includes a target bullet prop pickup parameter, and the target bullet prop pickup parameter is configured to: control to pick up a second bullet pickup quantity of bullets of the specified bullet type, where the specified bullet type matches the target ballistic device prop. The apparatus further includes a first pickup quantity determination module configured to: if the second bullet pickup quantity is different from the first bullet pickup quantity of bullets of the specified bullet type in the first target parameter, determine a greater value of the first bullet pickup quantity and the second bullet pickup quantity as the pickup quantity of bullets of the specified bullet type.

Multiple of the target ballistic device props are provided, and the multiple target ballistic device props all match bullets of the specified bullet type, multiple of the second bullet pickup quantities are provided, and the apparatus further includes a second pickup quantity determination module configured to: if the multiple second bullet pickup quantities are different, use the second bullet pickup quantity with the greatest value as the final second bullet pickup quantity.

The target configuration parameter further includes a target bullet prop pickup parameter, and the target bullet prop pickup parameter is configured to: control to pick up a second bullet pickup quantity of bullets of the specified bullet type, where the specified bullet type matches the target ballistic device prop. The apparatus further includes a third pickup quantity determination module configured to: if the second bullet pickup quantity is different from the first bullet pickup quantity of bullets of the specified bullet type in the first target parameter, determine the second bullet pickup quantity as the pickup quantity of bullets of the specified bullet type.

The target configuration parameter further includes a target sighting prop pickup parameter, and the target sighting prop pickup parameter is configured to: control to pick up a first sighting-device type set for the target ballistic device prop. The apparatus further includes a sighting device installation module configured: in response to the controlled virtual object moving to an interactive area of a pickable sighting device in the game scene, determine that the sighting-device type of the pickable sighting device is a first sighting-device type; and control the controlled virtual object to pick up the pickable sighting device and install the pickable sighting device on the target ballistic device prop.

The apparatus further includes a first sighting-device pickup control module configured to: in response to the controlled virtual object moving to an interactive area of the pickable sighting device in the game scene, determine that the sighting-device type of the pickable sighting device is a second sighting-device type, where the second sighting-device type is different from the first sighting-device type; and control the controlled virtual object not to pick up the pickable sighting device.

The first sighting-device type is a sighting-device type determined in response to a setting operation for the target sighting prop pickup parameter.

The apparatus further includes a sighting-device type determination module configured to: if the setting function for the target ballistic device prop is turned on and a setting operation of the target sighting prop pickup parameter for the target ballistic device prop is not received, acquire a default sighting-device type of the target ballistic device prop and determine the default sighting-device type as the first sighting-device type.

Multiple of the target ballistic device props are provided. The sighting device installation module is further configured to control the controlled virtual object to pick up the pickable sighting device; and acquire the position sequence numbers of the multiple target ballistic device props, and install the pickable sighting device on the target ballistic device prop with a position sequence number that meets a preset condition.

The apparatus further includes a second sighting-device pickup control module configured to: if the setting function for the target ballistic device prop is turned off, determine that the target configuration parameter is invalid; and control the controlled virtual object to pick up the sighting device in the game scene according to the sighting prop pickup parameter in the first target parameter.

The apparatus further includes a sighting-device assembly module configured to: control to place the picked-up sighting device in a virtual container carried by the controlled virtual object; and control to assemble the sighting device to the target ballistic device prop in response to an assembly operation for the sighting device in the virtual container.

The apparatus further includes a sighting device installation module configured to: in response to the controlled virtual object picking up the first ballistic device prop and the first ballistic device prop matching the picked-up sighting device in the virtual container carried by the controlled virtual object, install the picked-up sighting device on the first ballistic device prop.

The apparatus further includes an interface display module configured to: if the setting function for the target ballistic device prop is turned on, display a setting interface of the first target parameter in response to a triggering operation for the pickup function. In the setting interface of the first target parameter, a setting control for the sighting prop pickup parameter is not displayed, or the setting control for the sighting prop pickup parameter is in an untriggerable state.

The apparatus further includes a window display module configured to: in response to a triggering operation for the target ballistic device prop, display a parameter setting window for the target ballistic device prop. The parameter setting window includes a first setting control for the target auxiliary prop pickup parameter, a second setting control for the target bullet prop pickup parameter, and a third setting control for the target sighting prop pickup parameter of the target ballistic device prop.

The target bullet prop pickup parameter is configured to: control to pick up the second bullet pickup quantity of bullets of the specified bullet type, where the specified bullet type matches the target ballistic device prop. The apparatus further includes an adjustment module configured to: in response to the triggering operation for the second setting control for the target bullet prop pickup parameter, display the bullet pickup quantity adjustment control; and in response to the triggering operation for the bullet pickup quantity adjustment control, adjust the second bullet pickup quantity in the target bullet prop pickup parameter.

The present embodiment further provides an electronic device including a processor and a memory, where the memory has machine-executable instructions that can be executed by the processor stored therein, and the processor executes the machine-executable instructions to implement the interaction control method for a game. The electronic device may be a server or a touch terminal device.

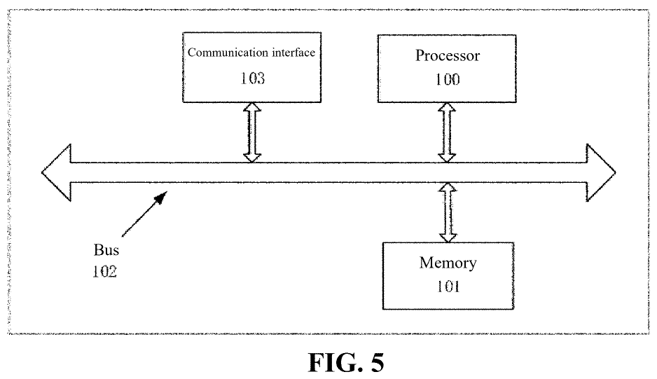

Referring to FIG. 5, the electronic device includes a processor 100 and a memory 101, where the memory 101 has machine-executable instructions that can be executed by the processor 100 stored therein, and the processor 100 executes the machine-executable instructions to implement the interaction control method for a game.

Furthermore, the electronic device shown in FIG. 5 further includes a bus 102 and a communication interface 103, and the processor 100, the communication interface 103, and the memory 101 are connected via the bus 102.

The memory 101 may include a high-speed Random Access Memory (RAM), and may also include a non-volatile memory, such as at least one disk memory. The communicative connection between the system network element and at least one other network element is realized through at least one communication interface 103 (which may be wired or wireless) by using the Internet, wide area network, local area network, metropolitan area network, or the like. The bus 102 may be an ISA bus, a PCI bus, an EISA bus, or the like. The bus may be classified into an address bus, a data bus, a control bus, and the like. For ease of representation, the bus is depicted in FIG. 5 with only one bidirectional arrow, but this does not mean that there is only one bus or one type of bus.

The processor 100 may be an integrated circuit chip having signal processing capabilities. During implementation, various steps of the above method can be completed by an integrated logic circuit of hardwares in the processor 100 or by instructions in the form of a software. The processor 100 may be a general-purpose processor, including a Central Processing Unit (CPU), a Network Processor (NP), and the like; it may be a Digital Signal Processor (DSP), an Application Specific Integrated Circuit (ASIC), a Field Programmable Gate Array (FPGA), or other programmable logic devices, discrete gates or transistor logic devices, discrete hardware components. The various methods, steps, and logical block diagrams disclosed in the embodiments of the present disclosure may be implemented or performed. A general purpose processor may be a microprocessor, or the processor may be any conventional processor or the like. The steps of the method disclosed in the embodiments of the present disclosure may be directly embodied as being performed by a hardware decoding processor, or may be embodied as being performed by a combination of hardware and software modules in the decoding processor. The software module may be located in a random access memory, a flash memory, a read-only memory, a programmable read-only memory, or an electrically erasable programmable memory, a register, or other mature storage media in the art. The storage medium is located in the memory 101, and the processor 100 reads the information in the memory 101 and completes the steps of the method of the embodiments described above in combination with its hardware.

The processor in the electronic device can implement the following operations in the interaction control method for a game described above by executing the machine-executable instructions:
providing a graphical user interface by a terminal device, where a scene screen of a game scene is displayed in the graphical user interface, a controlled virtual object is located in the game scene, and the controlled virtual object is controlled by the terminal device, and a pickable auxiliary prop is placed at a preset position in the game scene; controlling the controlled virtual object to move within the game scene, the controlled virtual object being assembled with a target ballistic device prop, the target ballistic device prop being assembled with a first auxiliary prop, and the first auxiliary prop being a prop that is picked up by the controlled virtual object according to a first target parameter or a prop that is picked up by the controlled virtual object in response to a pickup operation, where the first target parameter is the pickup parameter of the auxiliary prop suitable for the ballistic device prop provided by the game corresponding to a pickup function provided by the game, and the first target parameter includes an auxiliary prop pickup parameter; in response to the controlled virtual object moving to an interactive area of the auxiliary prop in the game scene, determining that the auxiliary prop is a target auxiliary prop that matches a target configuration parameter, where the target configuration parameter is a target configuration parameter of the target ballistic device prop that is determined in response to a setting operation and according to the setting operation, the target configuration parameter is the pickup parameter of the auxiliary prop suitable for the target ballistic device prop, and the target configuration parameter includes a target auxiliary prop pickup parameter; and controlling the controlled virtual object to pick up the target auxiliary prop and install the same on the target ballistic device prop, so as to replace a first auxiliary prop.

The auxiliary prop pickup parameter includes at least one of a muzzle prop pickup parameter, a magazine prop pickup parameter, a handgrip prop pickup parameter, and a buttstock prop pickup parameter; the auxiliary prop corresponding to each auxiliary prop pickup parameter is preset with at least one auxiliary model, and each auxiliary model is configured with a pickup priority; and the auxiliary prop pickup parameter is configured to: if the auxiliary model of the first auxiliary prop assembled on the target ballistic device prop is configured with a first priority, control to pick up the auxiliary model of the first auxiliary prop with a priority higher than the first priority in the game scene.

The first target parameter further includes a bullet prop pickup parameter, and the bullet prop pickup parameter is configured to: control to pick up a first bullet pickup quantity of bullets of a specified bullet type; and if the number of bullets of the specified bullet type that have been picked up reaches the first bullet pickup quantity, pick up no more bullets of the specified bullet type.

The first target parameter further includes a sighting prop pickup parameter, and the sighting prop pickup parameter is configured to: control to pick up the first sighting-device pickup quantity of sighting devices of a specified sighting-device type; and if the number of sighting devices of the specified sighting-device type that have been picked up reaches the first sighting-device pickup quantity, pick up no more sighting devices of the specified sighting-device type.

The target auxiliary prop pickup parameter includes a first auxiliary model of the target auxiliary set for the target ballistic device prop, and the target auxiliary prop pickup parameter is configured to: if the auxiliary type of the target auxiliary is preset with at least one auxiliary model, configure the first auxiliary model to have the highest pickup priority.

In response to the controlled virtual object moving to the interactive area of the auxiliary prop in the game scene, if the auxiliary type of the auxiliary prop is the same as the auxiliary type of the target auxiliary prop, and the auxiliary model of the auxiliary prop is the first auxiliary model, the auxiliary prop is determined to be a target auxiliary prop that matches the target configuration parameter.

In response to the controlled virtual object moving to the interactive area of the auxiliary prop in the game scene, it is determined that the auxiliary prop is an assemblable auxiliary prop that matches the type of the target ballistic device prop, and that the auxiliary model of the assemblable auxiliary prop is a second auxiliary model, where in the auxiliary prop pickup parameter of the first target parameter, the second auxiliary model has the highest pickup priority, and the second auxiliary model is different from the first auxiliary model; and it is determined that the auxiliary prop is not a target auxiliary prop that matches the target configuration parameter.

In response to the controlled virtual object moving to the interactive area of the auxiliary prop in the game scene, it is determined that the auxiliary type of the auxiliary prop is the same as the auxiliary type of the target auxiliary prop, and that the auxiliary model of the auxiliary prop is a third auxiliary model, where the third auxiliary model is different from the first auxiliary model; it is determined that the auxiliary type of the first auxiliary prop currently assembled on the target ballistic device prop is the same as the auxiliary type of the target auxiliary prop, and that the auxiliary model of the first auxiliary prop is a fourth auxiliary model, where the fourth auxiliary model is different from the first auxiliary model; the pickup priority for the third auxiliary model and the pickup priority for the fourth auxiliary model are acquired from the first target parameter; if the pickup priority of the third auxiliary model is lower than the pickup priority of the fourth auxiliary model, it is controlled not to automatically pick up the auxiliary prop; and if the pickup priority of the third auxiliary model is higher than the pickup priority of the fourth auxiliary model, it is controlled to pick up the auxiliary prop.

If a pickup function corresponding to the first target parameter is turned off, it is determined that the first target parameter is invalid, and it is controlled not to automatically pick up an auxiliary of a different auxiliary model from the target auxiliary.

The target configuration parameter further includes a target bullet prop pickup parameter, and the target bullet prop pickup parameter is configured to: control to pick up a second bullet pickup quantity of bullets of the specified bullet type, where the specified bullet type matches the target ballistic device prop; and if the second bullet pickup quantity is different from the first bullet pickup quantity of bullets of the specified bullet type in the first target parameter, a greater value of the first bullet pickup quantity and the second bullet pickup quantity is determined as the pickup quantity of bullets of the specified bullet type.

Multiple of the target ballistic device props are provided, and the multiple target ballistic device props all match bullets of the specified bullet type, multiple of the second bullet pickup quantities are provided, and if the multiple second bullet pickup quantities are different, the second bullet pickup quantity with the greatest value is used as the final second bullet pickup quantity.

The target configuration parameter further includes a target bullet prop pickup parameter, and the target bullet prop pickup parameter is configured to: control to pick up the second bullet pickup quantity of bullets of the specified bullet type, where the specified bullet type matches the target ballistic device prop. If the second bullet pickup quantity is different from the first bullet pickup quantity of bullets of the specified bullet type in the first target parameter, the second bullet pickup quantity is determined as the pickup quantity of bullets of the specified bullet type.

The target configuration parameter further includes a target sighting prop pickup parameter, and the target sighting prop pickup parameter is configured to: control to pick up a first sighting-device type set for the target ballistic device prop. In response to the controlled virtual object moving to an interactive area of a pickable sighting device in the game scene, it is determined that the sighting-device type of the pickable sighting device is a first sighting-device type; and the controlled virtual object is controlled to pick up the pickable sighting device and install the pickable sighting device on the target ballistic device prop.

In response to the controlled virtual object moving to the interactive area of the pickable sighting device in the game scene, it is determined that the sighting-device type of the pickable sighting device is a second sighting-device type, where the second sighting-device type is different from the first sighting-device type; and the controlled virtual object is controlled not to pick up the pickable sighting device.

The first sighting-device type is a sighting-device type determined in response to a setting operation for a target sighting prop pickup parameter.

If the setting function for the target ballistic device prop is turned on and a setting operation of the target sighting prop pickup parameter for the target ballistic device prop is not received, a default sighting-device type of the target ballistic device prop is acquired and the default sighting-device type is determined as the first sighting-device type.

Multiple of the target ballistic device props are provided; the controlled virtual object is controlled to pick up the pickable sighting device; and the position sequence numbers of the multiple target ballistic device props are acquired, and the pickable sighting device is installed on the target ballistic device prop with a position sequence number that meets a preset condition.

If the setting function for the target ballistic device prop is turned off, it is determined that the target configuration parameter is invalid; and the controlled virtual object is controlled to pick up a sighting device in the game scene according to the sighting prop pickup parameter in the first target parameter.

It is controlled to place the picked-up sighting device in a virtual container carried by the controlled virtual object; and it is controlled to assemble the sighting device to the target ballistic device prop in response to an assembly operation for the sighting device in the virtual container.

In response to the controlled virtual object picking up the first ballistic device prop and the first ballistic device prop matching the picked-up sighting device in the virtual container carried by the controlled virtual object, the picked-up sighting device is installed on the first ballistic device prop.

If the setting function for the target ballistic device prop is turned on, a setting interface of the first target parameter is displayed in response to a triggering operation for the pickup function; where in the setting interface of the first target parameter, a setting control for the sighting prop pickup parameter is not displayed, or the setting control for the sighting prop pickup parameter is in an untriggerable state.

In response to a triggering operation for the target ballistic device prop, a parameter setting window for the target ballistic device prop is displayed. The parameter setting window includes a first setting control for the target auxiliary prop pickup parameter, a second setting control for the target bullet prop pickup parameter, and a third setting control for the target sighting prop pickup parameter of the target ballistic device prop.

The target bullet prop pickup parameter is configured to: control to pick up the second bullet pickup quantity of bullets of the specified bullet type, where the specified bullet type matches the target ballistic device prop. In response to the triggering operation for the second setting control for the target bullet prop pickup parameter, the bullet pickup quantity adjustment control is displayed; and in response to the triggering operation for the bullet pickup quantity adjustment control, the second bullet pickup quantity in the target bullet prop pickup parameter is adjusted.

In this method, the first target parameter is an auxiliary prop pickup parameter for most ballistic device props, and the target configuration parameter is an auxiliary prop pickup parameter for the target ballistic device prop. Since the controlled virtual object carries the target ballistic device prop in the game play, by picking up an auxiliary prop through the target configuration parameter, the picked-up auxiliary prop can better match the target ballistic device prop and better conform with preferences and habits of the player, thereby improving the game achievement of the player. When the first target parameter conflicts with the target configuration parameter, by picking up the auxiliary prop through the target configuration parameter, confusion in the prop pickup logic can be avoided, thereby improving the game experience of the player.

The present embodiment further provides a machine-readable storage medium having machine-executable instructions stored therein, where the machine-executable instructions, when called and executed by a processor, cause the processor to implement the interaction control method for a game.

The machine-executable instructions stored in the machine-readable storage medium can implement the following operations in the interaction control method for a game by executing the machine-executable instructions:
providing a graphical user interface by a terminal device, where a scene screen of a game scene is displayed in the graphical user interface, a controlled virtual object is located in the game scene, and the controlled virtual object is controlled by the terminal device, and a pickable auxiliary prop is placed at a preset position in the game scene; controlling the controlled virtual object to move within the game scene, the controlled virtual object being assembled with a target ballistic device prop, the target ballistic device prop being assembled with a first auxiliary prop, and the first auxiliary prop being a prop that is picked up by the controlled virtual object according to a first target parameter or a prop that is picked up by the controlled virtual object in response to a pickup operation, where the first target parameter is the pickup parameter of the auxiliary prop suitable for the ballistic device prop provided by the game corresponding to a pickup function provided by the game, and the first target parameter includes an auxiliary prop pickup parameter; in response to the controlled virtual object moving to an interactive area of the auxiliary prop in the game scene, determining that the auxiliary prop is a target auxiliary prop that matches a target configuration parameter, where the target configuration parameter is a target configuration parameter of the target ballistic device prop that is determined in response to a setting operation and according to the setting operation, the target configuration parameter is the pickup parameter of the auxiliary prop suitable for the target ballistic device prop, and the target configuration parameter includes a target auxiliary prop pickup parameter; and controlling the controlled virtual object to pick up the target auxiliary prop and install the same on the target ballistic device prop, so as to replace a first auxiliary prop.

The auxiliary prop pickup parameter includes at least one of a muzzle prop pickup parameter, a magazine prop pickup parameter, a handgrip prop pickup parameter, and a buttstock prop pickup parameter; the auxiliary prop corresponding to each auxiliary prop pickup parameter is preset with at least one auxiliary model, and each auxiliary model is configured with a pickup priority; and the auxiliary prop pickup parameter is configured to: if the auxiliary model of the first auxiliary prop assembled on the target ballistic device prop is configured with a first priority, control to pick up the auxiliary model of the first auxiliary prop with a priority higher than the first priority in the game scene.

The first target parameter further includes a bullet prop pickup parameter, and the bullet prop pickup parameter is configured to: control to pick up a first bullet pickup quantity of bullets of a specified bullet type; and if the number of bullets of the specified bullet type that have been picked up reaches the first bullet pickup quantity, pick up no more bullets of the specified bullet type.

The first target parameter further includes a sighting prop pickup parameter, and the sighting prop pickup parameter is configured to: control to pick up the first sighting-device pickup quantity of sighting devices of a specified sighting-device type; and if the number of sighting devices of the specified sighting-device type that have been picked up reaches the first sighting-device pickup quantity, pick up no more sighting devices of the specified sighting-device type.

The target auxiliary prop pickup parameter includes a first auxiliary model of the target auxiliary set for the target ballistic device prop, and the target auxiliary prop pickup parameter is configured to: if the auxiliary type of the target auxiliary is preset with at least one auxiliary model, configure the first auxiliary model to have the highest pickup priority.

In response to the controlled virtual object moving to the interactive area of the auxiliary prop in the game scene, if the auxiliary type of the auxiliary prop is the same as the auxiliary type of the target auxiliary prop, and the auxiliary model of the auxiliary prop is the first auxiliary model, the auxiliary prop is determined to be a target auxiliary prop that matches the target configuration parameter.

In response to the controlled virtual object moving to the interactive area of the auxiliary prop in the game scene, it is determined that the auxiliary prop is an assemblable auxiliary prop that matches the type of the target ballistic device prop, and that the auxiliary model of the assemblable auxiliary prop is a second auxiliary model, where in the auxiliary prop pickup parameter of the first target parameter, the second auxiliary model has the highest pickup priority, and the second auxiliary model is different from the first auxiliary model; and it is determined that the auxiliary prop is not a target auxiliary prop that matches the target configuration parameter.

In response to the controlled virtual object moving to the interactive area of the auxiliary prop in the game scene, it is determined that the auxiliary type of the auxiliary prop is the same as the auxiliary type of the target auxiliary prop, and that the auxiliary model of the auxiliary prop is a third auxiliary model, where the third auxiliary model is different from the first auxiliary model; it is determined that the auxiliary type of the first auxiliary prop currently assembled on the target ballistic device prop is the same as the auxiliary type of the target auxiliary prop, and that the auxiliary model of the first auxiliary prop is a fourth auxiliary model, where the fourth auxiliary model is different from the first auxiliary model; the pickup priority for the third auxiliary model and the pickup priority for the fourth auxiliary model are acquired from the first target parameter; if the pickup priority of the third auxiliary model is lower than the pickup priority of the fourth auxiliary model, it is controlled not to automatically pick up the auxiliary prop; and if the pickup priority of the third auxiliary model is higher than the pickup priority of the fourth auxiliary model, it is controlled to pick up the auxiliary prop.

If a pickup function corresponding to the first target parameter is turned off, it is determined that the first target parameter is invalid, and it is controlled not to automatically pick up an auxiliary of a different auxiliary model from the target auxiliary.

The target configuration parameter further includes a target bullet prop pickup parameter, and the target bullet prop pickup parameter is configured to: control to pick up a second bullet pickup quantity of bullets of the specified bullet type, where the specified bullet type matches the target ballistic device prop; and if the second bullet pickup quantity is different from the first bullet pickup quantity of bullets of the specified bullet type in the first target parameter, a greater value of the first bullet pickup quantity and the second bullet pickup quantity is determined as the pickup quantity of bullets of the specified bullet type.

Multiple of the target ballistic device props are provided, and the multiple target ballistic device props all match bullets of the specified bullet type, multiple of the second bullet pickup quantities are provided, and if the multiple second bullet pickup quantities are different, the second bullet pickup quantity with the greatest value is used as the final second bullet pickup quantity.

The target configuration parameter further includes a target bullet prop pickup parameter, and the target bullet prop pickup parameter is configured to: control to pick up the second bullet pickup quantity of bullets of the specified bullet type, where the specified bullet type matches the target ballistic device prop. If the second bullet pickup quantity is different from the first bullet pickup quantity of bullets of the specified bullet type in the first target parameter, the second bullet pickup quantity is determined as the pickup quantity of bullets of the specified bullet type.

The target configuration parameter further includes a target sighting prop pickup parameter, and the target sighting prop pickup parameter is configured to: control to pick up a first sighting-device type set for the target ballistic device prop. In response to the controlled virtual object moving to an interactive area of a pickable sighting device in the game scene, it is determined that the sighting-device type of the pickable sighting device is a first sighting-device type; and the controlled virtual object is controlled to pick up the pickable sighting device and install the pickable sighting device on the target ballistic device prop.

In response to the controlled virtual object moving to the interactive area of the pickable sighting device in the game scene, it is determined that the sighting-device type of the pickable sighting device is a second sighting-device type, where the second sighting-device type is different from the first sighting-device type; and the controlled virtual object is controlled not to pick up the pickable sighting device.

The first sighting-device type is a sighting-device type determined in response to a setting operation for a target sighting prop pickup parameter.

If the setting function for the target ballistic device prop is turned on and a setting operation of the target sighting prop pickup parameter for the target ballistic device prop is not received, a default sighting-device type of the target ballistic device prop is acquired and the default sighting-device type is determined as the first sighting-device type.

Multiple of the target ballistic device props are provided; the controlled virtual object is controlled to pick up the pickable sighting device; and the position sequence numbers of the multiple target ballistic device props are acquired, and the pickable sighting device is installed on the target ballistic device prop with a position sequence number that meets a preset condition.

If the setting function for the target ballistic device prop is turned off, it is determined that the target configuration parameter is invalid; and the controlled virtual object is controlled to pick up a sighting device in the game scene according to the sighting prop pickup parameter in the first target parameter.

It is controlled to place the picked-up sighting device in a virtual container carried by the controlled virtual object; and it is controlled to assemble the sighting device to the target ballistic device prop in response to an assembly operation for the sighting device in the virtual container.

In response to the controlled virtual object picking up the first ballistic device prop and the first ballistic device prop matching the picked-up sighting device in the virtual container carried by the controlled virtual object, the picked-up sighting device is installed on the first ballistic device prop.

If the setting function for the target ballistic device prop is turned on, a setting interface of the first target parameter is displayed in response to a triggering operation for the pickup function; where in the setting interface of the first target parameter, a setting control for the sighting prop pickup parameter is not displayed, or the setting control for the sighting prop pickup parameter is in an untriggerable state.

In response to a triggering operation for the target ballistic device prop, a parameter setting window for the target ballistic device prop is displayed. The parameter setting window includes a first setting control for the target auxiliary prop pickup parameter, a second setting control for the target bullet prop pickup parameter, and a third setting control for the target sighting prop pickup parameter of the target ballistic device prop.

The target bullet prop pickup parameter is configured to: control to pick up the second bullet pickup quantity of bullets of the specified bullet type, where the specified bullet type matches the target ballistic device prop. In response to the triggering operation of the second setting control for the target bullet prop pickup parameter, the bullet pickup quantity adjustment control is displayed; and in response to the triggering operation for the bullet pickup quantity adjustment control, the second bullet pickup quantity in the target bullet prop pickup parameter is adjusted.

In this method, the first target parameter is an auxiliary prop pickup parameter for most ballistic device props, and the target configuration parameter is an auxiliary prop pickup parameter for the target ballistic device prop. Since the controlled virtual object carries the target ballistic device prop in the game play, by picking up an auxiliary prop through the target configuration parameter, the picked-up auxiliary prop can better match the target ballistic device prop and better conform with preferences and habits of the player, thereby improving the game achievement of the player. When the first target parameter conflicts with the target configuration parameter, by picking up the auxiliary prop through the target configuration parameter, confusion in the prop pickup logic can be avoided, thereby improving the game experience of the player.

The computer program product of the interaction control method and apparatus in a game and the electronic device provided by the embodiments of the present disclosure includes a computer-readable storage medium having program codes stored therein. The instructions included in the program codes can be used to perform the methods described in the foregoing method embodiments. The specific implementation may be obtained with reference to the method embodiments and description thereof will be omitted herein.

Those skilled in the art can clearly understand that, for the convenience and brevity of description, the specific operating process of the system and apparatus described above may be obtained with reference to the corresponding process in the foregoing method embodiments, and description thereof will be omitted herein.

In addition, in the description of the embodiments of the present disclosure, unless otherwise clearly specified and defined, the terms “mount,” “connect,” and “couple” should be interpreted in a broad sense, and for example, may be a fixed connection, a detachable connection, or an integral connection; may be a mechanical connection or an electrical connection; or may be a direct connection, an indirect connection via an intermediate medium, or communication between the interiors of two elements. For those skilled in the art, the specific meanings of the above terms in the present disclosure can be understood according to specific circumstances.

If the functions are implemented in the form of software functional units and sold or used as independent products, they can be stored in a computer-readable storage medium. Based on this understanding, the essential part or the part that contributes to the related art of the technical solution of the present disclosure or part of this technical solution can be embodied in the form of a software product. The computer software product is stored in a storage medium and includes several instructions to cause a computer device (which may be a personal computer, a server, a network device, or the like) to perform all or some of the steps of the methods described in various embodiments of the present disclosure. The aforementioned storage medium includes: a USB flash drive, a mobile hard disk, a Read-Only Memory (ROM), a Random Access Memory (RAM), a magnetic disk or optical disc, and other media that can store program codes.

In the description of the present disclosure, it should be noted that the terms “central,” “upper,” “lower,” “left,” “right,” “vertical,” “horizontal,” “inner,” “outer,” or the like, indicate orientations or positional relationships based on the orientations or positional relationships shown in the accompanying drawings, and are intended only for the convenience of describing the present disclosure and simplifying the description, and do not indicate or imply that the apparatus or element referred to must have a specific orientation, be constructed and operated in a specific orientation, and therefore should not be understood as limitation of the present disclosure. Furthermore, the terms “first,” “second,” and “third” are used for descriptive purposes only and should not be understood as indicating or implying relative importance.

Finally, it should be noted that the foregoing embodiments are only specific implementations of the present disclosure for illustrating rather than limiting the technical solutions of the present disclosure. The protection scope of the present disclosure is not limited thereto. Although the present disclosure has been described in detail with reference to the foregoing embodiments, those skilled in the art should understand that within the technical scope disclosed in the present disclosure, any technician familiar with the technical field can still modify the technical solutions recited in the foregoing embodiments or easily conceive of changes, or make equivalent replacements for some of the technical features therein. Such modifications, changes, or replacements do not deviate the essence of the corresponding technical solutions from the spirit and scope of the technical solutions of the embodiments of the present disclosure, and should all be covered by the protection scope of the present disclosure. Therefore, the protection scope of the present disclosure should be based on the protection scope of the claims.

1. A method for controlling interactions in a game, comprising:
controlling a controlled virtual object to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation, wherein:
the first target parameter is a pickup parameter of a target auxiliary prop applicable to the target ballistic device prop provided by the game corresponding to a pickup function provided by the game,
the first target parameter comprises a target auxiliary prop pickup parameter,
the game scene is displayed on a graphical user interface of a terminal device,
the controlled virtual object is located in the game scene and controlled by the terminal device, and
a pickable auxiliary prop is placed at a preset position in the game scene;
in response to the controlled virtual object moving to an interactive area of the pickable auxiliary prop in the game scene, determining that the pickable auxiliary prop is the target auxiliary prop that matches a target configuration parameter, wherein:
the target configuration parameter is determined in response to a setting operation, and
the target configuration parameter comprise the first target parameter
controlling the controlled virtual object to pick up the target auxiliary prop; and
installing the target auxiliary prop on the target ballistic device prop to replace the first auxiliary prop.

2. The method according to claim 1, wherein the auxiliary prop pickup parameter comprises at least one of: a muzzle prop pickup parameter, a magazine prop pickup parameter, a handgrip prop pickup parameter, and a buttstock prop pickup parameter,
each auxiliary prop pickup parameter is preset with at least one auxiliary model, and each auxiliary model is configured with a pickup priority, and
in response to an auxiliary model of the first auxiliary prop assembled on the target ballistic device prop is configured with a first priority, the auxiliary prop pickup parameter is configured to pick up an auxiliary model of the first auxiliary prop with a priority higher than the first priority in the game scene.

3. The method according to claim 1, wherein the first target parameter further comprises a bullet prop pickup parameter, and the bullet prop pickup parameter is configured to:
control to pick up a first quantity of bullets corresponding to a specified bullet type; and
in response to a number of the bullets corresponding to the specified bullet type that have been picked up reaching the first quantity, stop the picking up operation.

4. The method according to claim 1, wherein the first target parameter further comprises a sighting prop pickup parameter, and the sighting prop pickup parameter is configured to:
control to pick up a first quantity of sighting devices corresponding to a specified sighting-device type; and
if in response to a number of the sighting devices corresponding to the specified sighting-device type that have been picked up reaching the first quantity, stop the picking up operation.

5. The method according to claim 1, wherein the target auxiliary prop pickup parameter comprises a first auxiliary model set for the target ballistic device prop, and the target auxiliary prop pickup parameter is configured to:
if in response to a preset type the target auxiliary prop comprises at least one auxiliary model, configure the first auxiliary model with a highest pickup priority.

6. The method according to claim 5, wherein in response to the controlled virtual object moving to the interactive area of the pickable auxiliary prop in the game scene, determining that the pickable auxiliary prop is the target auxiliary prop that matches the target configuration parameter comprises:
in response to the controlled virtual object moving to the interactive area of the pickable auxiliary prop in the game scene, a type of the pickable auxiliary prop is the same as a type of the target auxiliary prop, and an auxiliary model of the pickable auxiliary prop comprises the first auxiliary model, determining the pickable auxiliary prop as the target auxiliary prop that matches the target configuration parameter.

7. The method according to claim 6, wherein after installing the target auxiliary prop on the target ballistic device prop to replace the first auxiliary prop, the method further comprises:
in response to the controlled virtual object moving to the interactive area of a second pickable auxiliary prop in the game scene, determining that a type of the second pickable auxiliary prop matches a type of the target ballistic device prop, and that an auxiliary model of the second pickable auxiliary prop comprises a second auxiliary model, wherein the second auxiliary model has a highest pickup priority within the target auxiliary prop pickup parameter of the first target parameter, and the second auxiliary model is different from the first auxiliary model; and
determining that the second pickable auxiliary prop is not the target auxiliary prop that matches the target configuration parameter.

8. The method according to claim 5, wherein before in response to the controlled virtual object moving to the interactive area of the pickable auxiliary prop in the game scene, determining that the pickable auxiliary prop is the target auxiliary prop that matches the target configuration parameter, the method further comprises:
in response to the controlled virtual object moving to the interactive area of the pickable auxiliary prop in the game scene, determining that a type of the pickable auxiliary prop is the same as a type of the target auxiliary prop, and an auxiliary model of the pickable auxiliary prop comprises a third auxiliary model, wherein the third auxiliary model is different from the first auxiliary model;
determining that a type of the first auxiliary prop currently assembled on the target ballistic device prop is the same as a type of the target auxiliary prop, an auxiliary model of the first auxiliary prop being comprises a fourth auxiliary model, wherein the fourth auxiliary model is different from the first auxiliary model;
acquiring a pickup priority for the third auxiliary model and a pickup priority for the fourth auxiliary model from the first target parameter;
in response to the pickup priority of the third auxiliary model is lower than the pickup priority of the fourth auxiliary model, controlling not to pick up the pickable auxiliary prop; and
in response to the pickup priority of the third auxiliary model is higher than the pickup priority of the fourth auxiliary model, controlling to pick up the pickable auxiliary prop.

9. The method according to claim 5, further comprising:
in response to the pickup function corresponding to the first target parameter is turned off, determining that the first target parameter is invalid, and controlling not to pick up an auxiliary prop having an auxiliary model differs from the target auxiliary prop.

10. The method according to claim 1, wherein the target configuration parameter further comprises a target bullet prop pickup parameter,
the target bullet prop pickup parameter is configured to control to pick up a second quantity of bullets corresponding to a specified bullet type, wherein the specified bullet type matches the target ballistic device prop, and
the method further comprises:
in response to the second quantity is different from a first quantity of the bullets corresponding to the specified bullet type in the first target parameter, determining a greater value of the first quantity and the second quantity as a pickup quantity of the bullets corresponding to the specified bullet type.

11. The method according to claim 10, wherein a plurality of the target ballistic device props are provided, the plurality of the target ballistic device props match the specified bullet type, a plurality of the second quantities are provided, and the method further comprises:
in response to the plurality of the second quantities are different, determine a maximum value among the plurality of the second quantities as a final second quantity.

12. The method according to claim 1, wherein the target configuration parameter further comprises a target bullet prop pickup parameter
the target bullet prop pickup parameter is configured to control to pick up a second quantity of bullets corresponding to a specified bullet type, wherein the specified bullet type matches the target ballistic device prop, and
the method further comprises:
in response to the second quantity is different from a first quantity of the bullets corresponding to the specified bullet type in the first target parameter, determining the second quantity as a pickup quantity of the bullets corresponding to the specified bullet type.

13. The method according to claim 1, wherein the target configuration parameter further comprises a target sighting prop pickup parameter,
the target sighting prop pickup parameter is configured to control to pick up the target ballistic device prop with a first sighting-device-type, and
the method further comprises:
in response to the controlled virtual object moving to an interactive area of a pickable sighting device in the game scene, determining that the pickable sighting device comprises the first sighting-device type;
controlling the controlled virtual object to pick up the pickable sighting device; and
installing the pickable sighting device on the target ballistic device prop.

14. The method according to claim 13, further comprising:
in response to the controlled virtual object moving to the interactive area of the pickable sighting device in the game scene, determining that the pickable sighting device comprises a second sighting-device type, the second sighting-device type being different from the first sighting-device type; and
controlling the controlled virtual object not to pick up the pickable sighting device.

15. The method according to claim 13, wherein the first sighting-device type comprises a sighting-device type that is determined in response to a setting operation for the target sighting prop pickup parameter.

16. The method according to claim 13, further comprising:
in response to a setting function for the target ballistic device prop is turned on and the target sighting prop pickup parameter for the target ballistic device prop is not received, acquiring a default sighting-device type of the target ballistic device prop, and determining the default sighting-device type as the first sighting-device type.

17. The method according to claim 13, wherein a plurality of the target ballistic device props are provided, and installing the pickable sighting device on the target ballistic device prop comprises:
acquiring position sequence number for each of the plurality of the target ballistic device props; and
installing the pickable sighting device on the target ballistic device prop with the position sequence number that meets a preset condition.

18. The method according to claim 13, further comprising:
in response to a the setting function for the target ballistic device prop is turned off, determining that the target configuration parameter is invalid; and
controlling the controlled virtual object to pick up the pickable sighting device in the game scene according to the target sighting prop pickup parameter in the first target parameter.

19. The method according to claim 18, wherein after controlling the controlled virtual object to pick up the pickable sighting device in the game scene according to the target sighting prop pickup parameter in the first target parameter, the method further comprises:
controlling to place the picked-up sighting device in a virtual container carried by the controlled virtual object; and
controlling to assemble the picked-up sighting device to the target ballistic device prop in response to an assembly operation.

20. The method according to claim 19, further comprising:
in response to the controlled virtual object picking up the target ballistic device prop, and the target ballistic device prop matching the picked-up sighting device in the virtual container carried by the controlled virtual object, installing the picked-up sighting device on the target ballistic device prop.

21. The method according to claim 13, further comprising:
in response to a function for the target ballistic device prop is turned on, displaying a setting interface of the first target parameter in response to a triggering operation for the pickup function, wherein, within the setting interface of the first target parameter, a setting control for a sighting prop pickup parameter is not displayed, or the setting control is displayed in an untriggerable state.

22. The method according to claim 1, wherein before controlling the controlled virtual object to move in the game scene, the method further comprises:
in response to a triggering operation for the target ballistic device prop, displaying a parameter setting window for the target ballistic device prop, the parameter setting window comprising a first setting control for a target auxiliary prop pickup parameter, a second setting control for a target bullet prop pickup parameter, and a third setting control for a target sighting prop pickup parameter of the target ballistic device prop.

23. The method according to claim 22, wherein the target bullet prop pickup parameter is configured to control a second quantity of bullets of corresponding to a specified bullet type, wherein the specified bullet type matches the target ballistic device prop, and
the method further comprises:
in response to response to the triggering operation for the second setting control for the target bullet prop pickup parameter, displaying a bullet pickup quantity adjustment control; and
in response to the triggering operation for the bullet pickup quantity adjustment control, adjusting the second quantity in the target bullet prop pickup parameter.

24. (canceled)

25. A system, comprising:
one or more memories collectively containing one or more programs; and
one or more processors, wherein the one or more processors are configured to, individually or collectively, perform an operation comprising:
controlling a controlled virtual object to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation, wherein:
the first target parameter is a pickup parameter of a target auxiliary prop applicable to the target ballistic device prop provided by a game corresponding to a pickup function provided by the game,
the first target parameter comprises a target auxiliary prop pickup parameter,
the game scene is displayed on a graphical user interface of a terminal device,
the controlled virtual object is located in the game scene and controlled by the terminal device, and
a pickable auxiliary prop is placed at a preset position in the game scene;
in response to the controlled virtual object moving to an interactive area of the pickable auxiliary prop in the game scene, determining that the pickable auxiliary prop is the target auxiliary prop that matches a target configuration parameter, wherein:
the target configuration parameter is determined in response to a setting operation, and
the target configuration parameter comprise the first target parameter;
controlling the controlled virtual object to pick up the target auxiliary prop; and
installing the target auxiliary prop on the target ballistic device prop to replace the first auxiliary prop.

26. One or more non-transitory computer-readable storage media containing, in any combination, computer program code that, when executable by a computer system, perform an operation comprising:
controlling a controlled virtual object to move within a game scene, the controlled virtual object being assembled with a target ballistic device prop, the target ballistic device prop being assembled with a first auxiliary prop, and the first auxiliary prop being picked up by the controlled virtual object according to a first target parameter or in response to a pickup operation, wherein:
the first target parameter is a pickup parameter of a target auxiliary prop applicable to the target ballistic device prop provided by a game corresponding to a pickup function provided by the game,
the first target parameter comprises a target auxiliary prop pickup parameter,
the game scene is displayed on a graphical user interface of a terminal device,
the controlled virtual object is located in the game scene and controlled by the terminal device, and
a pickable auxiliary prop is placed at a preset position in the game scene;
in response to the controlled virtual object moving to an interactive area of the pickable auxiliary prop in the game scene, determining that the pickable auxiliary prop is the target auxiliary prop that matches a target configuration parameter, wherein:
the target configuration parameter is determined in response to a setting operation, and
the target configuration parameter comprise the first target parameter;
controlling the controlled virtual object to pick up the target auxiliary prop; and
installing the target auxiliary prop on the target ballistic device prop to replace the first auxiliary prop.
